(19) United States
(12) Patent Application Publication
(10) Pub. No.: US 2018/0358003 A1
(43) Pub. Date: Dec. 13, 2018

(54) METHODS AND APPARATUS FOR IMPROVING SPEECH COMMUNICATION AND SPEECH INTERFACE QUALITY USING NEURAL NETWORKS

(71) Applicant: QUALCOMM Incorporated, San Diego, CA (US)

(72) Inventors: Richard Anthony CALLE, San Francisco, CA (US); M Anthony LEWIS, La Jolla, CA (US)

(21) Appl. No.: 15/618,424

(22) Filed: Jun. 9, 2017

(51) Int. Cl. G10L 15/183; G10L 15/06; G10L 15/16

(52) U.S. Cl. CPC G10L 15/183; G10L 15/16; G10L 15/063

(57) ABSTRACT

A method, a computer-readable medium, and an apparatus for improving speech quality are provided. The apparatus may be a UE. The apparatus may receive a first voice stream from a remote UE. The apparatus may construct, by using a neural network, a second voice stream based on the first voice stream. The neural network may provide one or more voice models for the constructing the second voice stream. In another aspect, an apparatus may generate a voice stream using a neural network. The neural network may provide a set of voice models, which may include generic voice models. The neural network may provide a custom voice model associated with a talker at the apparatus. The apparatus may send the voice stream over an in-band communication channel.

### BACKGROUND

### Field

The present disclosure relates generally to machine learning, and more particularly, to improving speech communication and speech interface quality using neural networks.

### Background

An artificial neural network, which may include an interconnected group of artificial neurons, may be a computational device or may represent a method to be performed by a computational device. Artificial neural networks may have corresponding structure and/or function in biological neural networks. However, artificial neural networks may provide useful computational techniques for certain applications in which conventional computational techniques may be cumbersome, impractical, or inadequate. Because artificial neural networks may infer a function from observations, such networks may be useful in applications where the complexity of the task or data makes the design of the function by conventional techniques burdensome.

Convolutional neural networks are a type of feed-forward artificial neural network. Convolutional neural networks may include collections of neurons that each has a receptive field and that collectively tile an input space. Convolutional neural networks (CNNs) have numerous applications. In particular, CNNs have broadly been used in the area of pattern recognition and classification.

Speech quality may be poor over conventional cellular/mobile communications because codec trans-coding, wireless dropout, and un-correctable corruption in the transmitted speech created by codec and noise suppression. The poor speech quality may detrimentally affect user experience of every mobile phone user. In addition, speech quality from speakerphones may be poor due to changed voice characteristics, environmental noise that may be difficult to filter, and room echo that may corrupt the voice. As few microphones are used for collecting speech signals to reduce cost and size of the devices, poor speech quality may result. Speech interfaces such as Internet of things (IoT) smart speakers may have poor speech recognition accuracy because the above speakerphone problem and the environmental noise that corrupts the speech signal. Therefore, improve speech communication and speech interface quality may be desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Whispering voice may be difficult to be heard clearly on the receiving end. In one configuration, to improve speech communication and speech interface quality, whispering voice may be reconstructed into natural voice. Voice signals generated by speakerphones and IoT devices may be distorted and difficult to understand on the receiving end, even with beam forming. In one configuration, to improve speech communication and speech interface quality, speech signals generated by speakerphones and IoT devices may be reconstructed to sound like wired, close-up phone calls on the receiving end. Interfering talkers may detrimentally affect speech quality. In one configuration, to improve speech communication and speech interface quality, attention may be focused on primary talker through saliency methods.

In an aspect of the disclosure, a method, a computer-readable medium, and an apparatus for wireless communication are provided. The apparatus may be a user equipment (UE). The apparatus may receive a first voice stream from a remote UE. The apparatus may construct, by using a neural network, a second voice stream based on the first voice stream. The neural network may provide one or more voice models for the constructing the second voice stream.

In another aspect of the disclosure, a method, a computer-readable medium, and an apparatus for wireless communication are provided. The apparatus may be a UE. The apparatus may generate a voice stream using a neural network. The neural network may provide a set of voice models, which may include generic voice models. The neural network may provide a custom voice model associated with a talker at the UE. The apparatus may send the voice stream over an in-band communication channel.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a neural network in accordance with aspects of the present disclosure.

FIG. 2 is a block diagram illustrating an exemplary deep convolutional network (DCN) in accordance with aspects of the present disclosure.

FIG. 3 is a diagram illustrating an example of applying voice reconstruction using a neural network on a receiving UE in a wireless communication system.

FIG. 4 is a diagram illustrating another example of applying voice reconstruction using a neural network in a receiving UE in a wireless communication system.

FIG. 5 is a flowchart of a method of wireless communication.

FIG. 6 is a diagram illustrating an example of applying voice reconstruction using a neural network to increase speakerphone voice quality.

FIG. 7 is a diagram illustrating an example of using neural networks to increase speakerphone voice quality.

FIG. 8 is a block diagram illustrating an example of voice reconstruction.

FIG. 9 are diagrams illustrating an example of using CNN with direct convolution of normalized voice samples.

FIG. 10 is a flowchart of a method of wireless communication.

FIG. 11 is a conceptual data flow diagram illustrating the data flow between different means/components in an exemplary apparatus.

FIG. 12 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of computing systems for artificial neural networks will now be presented with reference to various apparatus and methods. The apparatus and methods will be described in the following detailed description and illustrated in the accompanying drawings by various blocks, components, circuits, processes, algorithms, etc. (collectively referred to as “elements”). The elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. In one configuration, specialized hardware may be built for processing neural networks. These engines may or may not have separate memory element. It may be possible that memory and computation are co-mingled (as in real biological tissue, or neuromorphic computing).

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

An artificial neural network may be defined by three types of parameters: 1) the interconnection pattern between and within the different layers of neurons; 2) the learning process for updating the weights of the interconnections; and 3) the activation function that converts a neuron's weighted input to its output activation. Neural networks may be designed with a variety of connectivity patterns. In feed-forward networks, information is passed from lower to higher layers, with each neuron in a given layer communicating with neurons in higher layers. A hierarchical representation may be built up in successive layers of a feed-forward network. Neural networks may also have recurrent or feedback (also called top-down) connections. In a recurrent connection, the output from a neuron in a given layer may be communicated to itself or another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. Examples of recurrent neural networks include Long Short-Term Memories (LSTMs), and Gated Recurrent Units (GRUs).

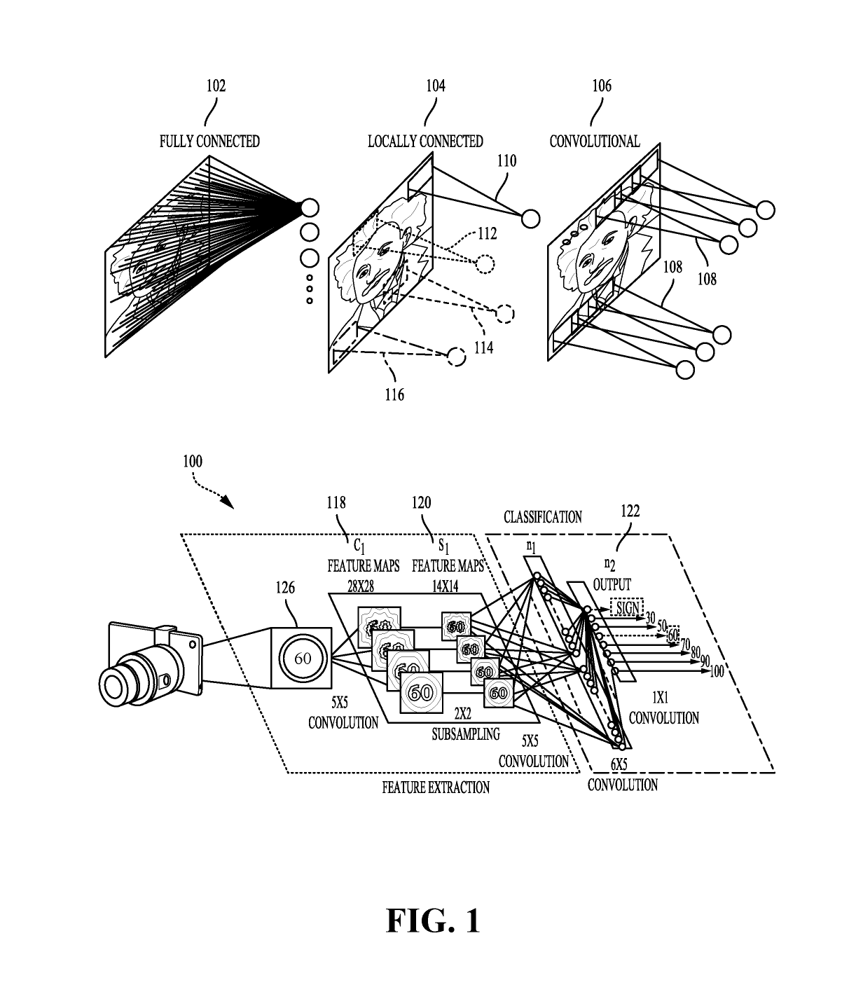

FIG. 1 is a diagram illustrating a neural network in accordance with aspects of the present disclosure. As shown in FIG. 1, the connections between layers of a neural network may be fully connected 102 or locally connected 104. In a fully connected network 102, a neuron in a first layer may communicate the neuron's output to every neuron in a second layer, so that each neuron in the second layer receives an input from every neuron in the first layer. Alternatively, in a locally connected network 104, a neuron in a first layer may be connected to a limited number of neurons in the second layer. A convolutional network 106 may be locally connected, and is further configured such that the connection strengths associated with the inputs for each neuron in the second layer are shared (e.g., connection strength 108). More generally, a locally connected layer of a network may be configured so that each neuron in a layer will have the same or a similar connectivity pattern, but with connections strengths that may have different values (e.g., 110, 112, 114, and 116). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a neural network 100 designed to recognize visual features from a car-mounted camera may develop high layer neurons with different properties depending on their association with the lower portion of the image versus the upper portion of the image. Neurons associated with the lower portion of the image may learn to recognize lane markings, for example, while neurons associated with the upper portion of the image may learn to recognize traffic lights, traffic signs, and the like. Similarly, in a spectral image certain neurons may focus on fundamental frequencies of human voice other neurons may learn the relationship between harmonics.

A deep convolutional network (DCN) may be trained with supervised learning. During training, a DCN may be presented with an image, such as a cropped image of a speed limit sign 126, and a “forward pass” may then be computed to produce an output 122. In an aspect, the image may be the output of a MFCC or Spectrogram or other filter that can be considered a 2 or 3 dimensional image. Accordingly, the following discussion, while describing common images due to their familiarity, may be applied to images of acoustic phenomenon equally. The output 122 may be a vector of values corresponding to features such as “sign,” “60,” and “100.” The network designer may want the DCN to output a high score for some of the neurons in the output feature vector, for example the ones corresponding to “sign” and “60” as shown in the output 122 for a neural network 100 that has been trained. Before training, the output produced by the DCN is likely to be incorrect, and so an error may be calculated between the actual output of the DCN and the target output desired from the DCN. The weights of the DCN may then be adjusted so that the output scores of the DCN are more closely aligned with the target output.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers as well as the feed forward activation of each individual neuron. The weights may then be adjusted so as to reduce the error. This manner of adjusting the weights may be referred to as “back propagation” as the manner of adjusting weights involves a “backward pass” through the neural network.

In practice, the error gradient of weights may be calculated over a small number of examples, so that the calculated gradient approximates the true error gradient. This approximation method may be referred to as a stochastic gradient descent. The stochastic gradient descent may be repeated until the achievable error rate of the entire system has stopped decreasing or until the error rate has reached a target level.

After learning, the DCN may be presented with new images 126 and a forward pass through the network may yield an output 122 that may be considered an inference or a prediction of the DCN.

Deep convolutional networks (DCNs) are networks of convolutional networks, configured with additional pooling and normalization layers. DCNs may achieve state-of-the-art performance on many tasks. DCNs may be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. In some cases, the computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered a three-dimensional network, with two spatial dimensions along the axes of the image and a third dimension capturing color information. In the case of an acoustic signal, two channels may represent the output of a spectral decomposition and represent phase as well as amplitude information. The outputs of the convolutional connections may be considered to form a feature map in the subsequent layers 118 and 120, with each element of the feature map (e.g., 120) receiving input from a range of neurons in the previous layer (e.g., 118) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

In one configuration, the input to the neural network 100 may be representation of speech. For example, the input to the neural network 100 may be a spectrogram, which is a visual representation of the spectrum of frequencies in a sound or other signal as they vary with time or some other variable. In one configuration, the input to the neural network 100 may be mel-frequency cepstral coefficients (MFCCs). MFCCs are coefficients that collectively make up a mel-frequency cepstrum (MFC), which is a representation of the short-term power spectrum of a sound, based on a linear cosine transform of a log power spectrum on a nonlinear mel scale of frequency.

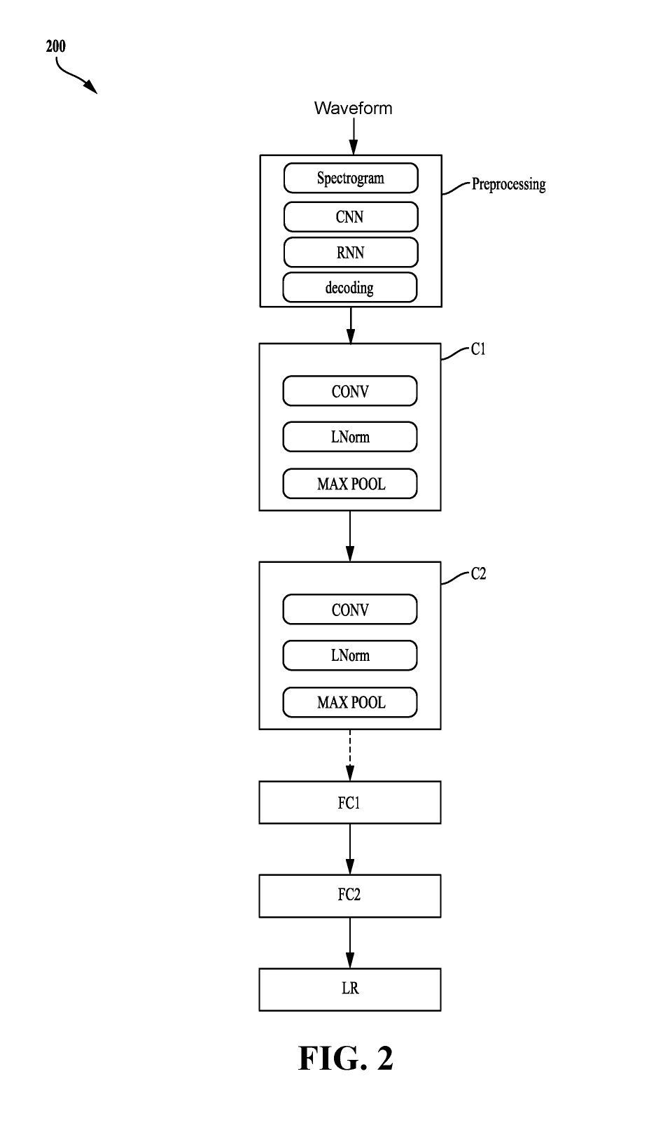

FIG. 2 is a block diagram illustrating an exemplary deep convolutional network 200. The deep convolutional network 200 may include multiple different types of layers based on connectivity and weight sharing. As shown in FIG. 2, the exemplary deep convolutional network 200 includes a preprocessing block. The preprocessing block has a waveform input. The preprocessing block includes a spectrogram block, convolutional neural network (CNN) block, recurrent neural network (RNN) block, and a decoding block. RNNs may come in a variety of forms including generic RNN, LSTM, and GRU, which may be designed with stable memory allowing association over long input sequences of indefinite lengths. The RNNs, in contrast to CNNs, may not require a predetermined window size for processing. RNNs may allow for more compact processing. The exemplary deep convolutional network 200 also includes multiple convolution blocks (e.g., C1 and C2). Each of the convolution blocks may be configured with a convolution layer (CONV), a normalization layer (LNorm), and a pooling layer (MAX POOL). The convolution layers may include one or more convolutional filters, which may be applied to the input data to generate a feature map. Although two convolution blocks are shown, the present disclosure is not so limiting, and instead, any number of convolutional blocks may be included in the deep convolutional network 200 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU or GPU of an SOC, optionally based on an Advanced RISC Machine (ARM) instruction set, to achieve high performance and low power consumption. In alternative embodiments, the parallel filter banks may be loaded on the DSP or an image signal processor (ISP) of an SOC. In addition, the DCN may access other processing blocks that may be present on the SOC, such as processing blocks dedicated to sensors and navigation.

The deep convolutional network 200 may also include one or more fully connected layers (e.g., FC1 and FC2). The fully connected layers (e.g., FC1 and FC2) may be RNN layers. The deep convolutional network 200 may further include a non-linear regression layer. The nonlinearity may include, but is not limited to logistic regression (LR), tanh, or more typical RELU (Rectified Linear Unit) layer. Between each layer of the deep convolutional network 200 are weights (not shown) that may be updated. The output of each layer may serve as an input of a succeeding layer in the deep convolutional network 200 to learn hierarchical feature representations from input data (e.g., images, audio, video, sensor data and/or other input data) supplied at the first convolution block C1.

The neural network 100 or the deep convolutional network 200 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software component executed by a processor, or any combination thereof. The neural network 100 or the deep convolutional network 200 may be utilized in a large range of applications, such as image and pattern recognition, machine learning, motor control, and the like. Each neuron in the neural network 100 or the deep convolutional network 200 may be implemented as a neuron circuit.

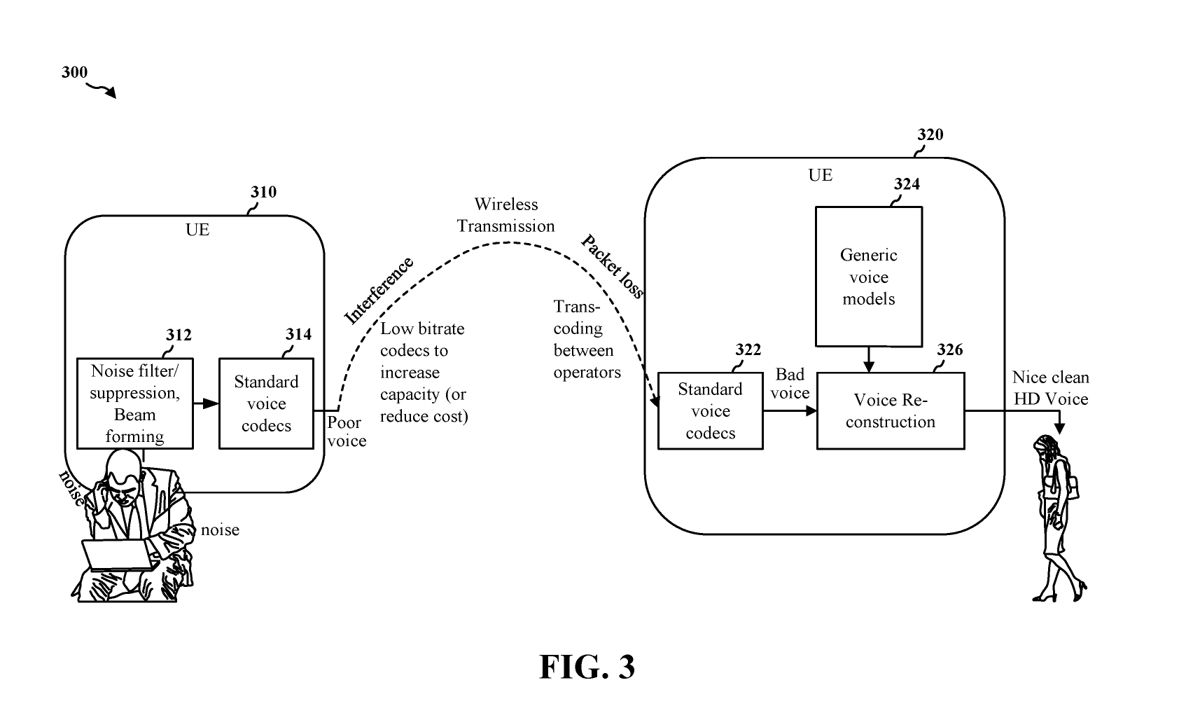

In certain aspects, the neural network 100 or the deep convolutional network 200 may be configured to reconstruct a voice stream to improve speech communication and speech interface quality. The neural network 100 or the deep convolutional network 200 may be configured to generate a voice stream using a neural network to improve speech communication and speech interface quality. The operations performed by the neural network 100 or the deep convolutional network 200 will be described below with reference to FIGS. 3-12.

FIG. 3 is a diagram illustrating an example of applying voice reconstruction using a neural network on a receiving UE 320 in a wireless communication system 300. In the example, the wireless communication system 300 may include UEs 310 and 320 that are involved in a wireless voice call session. The UE 310 may be a conventional UE that is used to send a speech signal to the UE 320. Therefore, the UE 310 may be a sending UE and the UE 320 may be a receiving UE.

Examples of UEs may include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The UE 310 may include a noise filter/suppression, beam-forming component 312 that filters or suppresses noise and performs beam forming on the speech signal picked up by one or more microphones of the UE 310. The UE 310 may include standard voice codecs 314 that encodes the speech signal after the speech signal is processed by the component 312 for transmission to the UE 320. Because of the environmental noise surrounding the UE 310, as well as the processing by the component 312 and standard voice codecs 314, the quality of the speech signal transmitted by the UE 310 may be poor. The quality of the speech signal may be further decreased during transmission due to interference, packet loss, and/or trans-coding between operators.

The UE 320 may include standard voice codecs 322 that decode the received speech signal to obtain a voice stream. The quality of the voice stream may be poor due to the reasons described above. The UE 320 may include a voice reconstruction block 326 that reconstructs the voice stream generated by the standard voice codecs 322 using a neural network to enhance the quality of the speech. As a result, the user of the UE 320 may be able to hear a clean high definition (HD) voice (e.g., with increased SNR and/or fewer artifacts).

In one configuration, the voice reconstruction block 326 may be embedded with generic voice models 324 in order to increase speech quality. The generic voice models 324 may include learned generic voice models (e.g., deep learning generative CNNs) for various languages, sexes, ages, accents, regional dialects, or prosody. The voice reconstruction block 326 may apply one or more of the generic voice models 324 to the voice stream generated by the standard voice codecs 322 based on an initial analysis of the voice stream. In one configuration, the initial analysis of the voice stream may be performed by a neural network.

In one configuration, the UE 310 may further include an automatic speech recognition (ASR) engine (not shown) that generates a text stream based on the speech signal, e.g., after the speech signal is processed by the component 312. The UE 310 may transmit the text stream to the UE 320 via an out of band communication channel (e.g., cloud infrastructure, peer-to-peer communications, or text message/MMS channels). The voice reconstruction block 326 may use the received text stream during the reconstruction of the voice stream to increase speech quality. In some circumstances the ASR may be constructed a neural network with convolutional layers acting on speech features, including MFCC, spectrogram and gammatone features, or conceivably on the audio signal itself, given sufficient processing power. In addition, the ASR may contain various RNN layers including bi-direction RNN. Examples of specialized RNNs include LSTM (long short-term memory) units and GRU (gated recurrent units), which may further be configure to process incoming data front-to-back, or in the case of buffered data, both front-to-back and back-to-front, creating a so called bidirectional RNN networks that is known to improve accuracy.

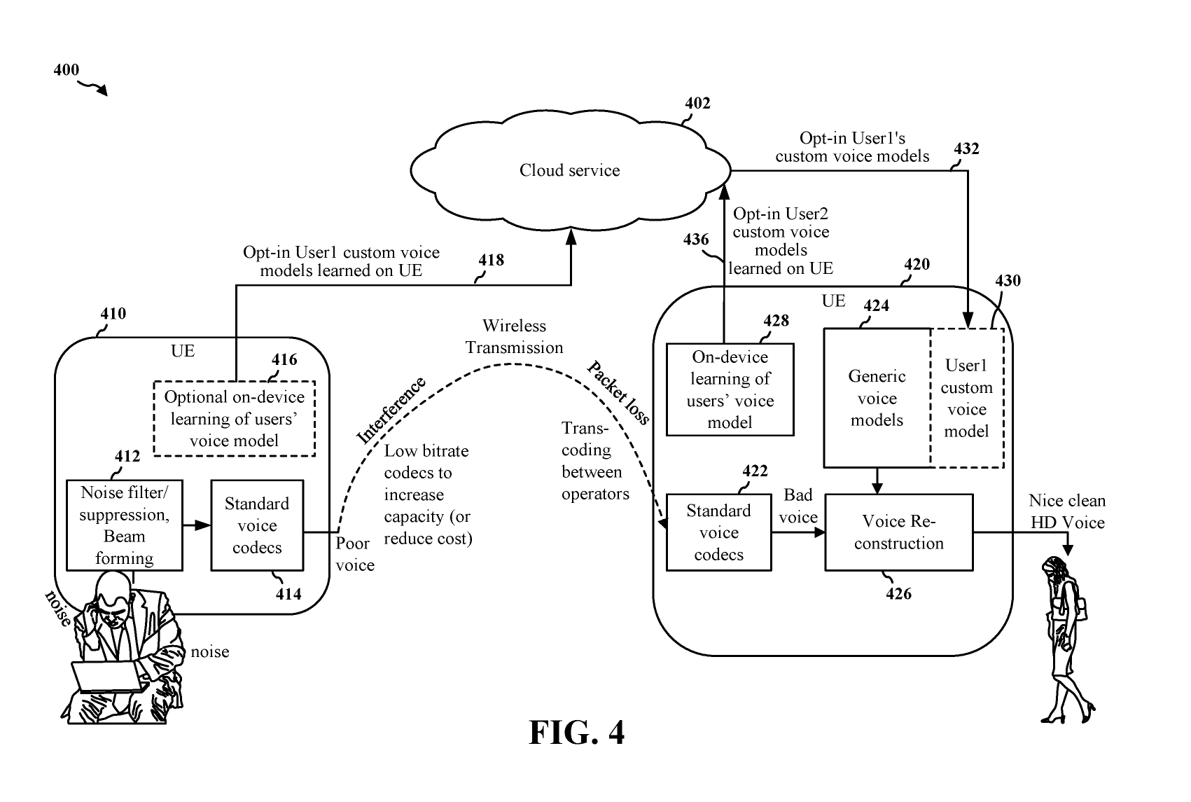

FIG. 4 is a diagram illustrating another example of applying voice reconstruction using a neural network in a receiving UE 420 in a wireless communication system 400. In the example, the wireless communication system 400 may include UEs 410 and 420 that are involved in a wireless voice call session. The UE 410 may send a speech signal to the UE 420. Therefore, the UE 410 may be a sending UE and the UE 420 may be a receiving UE. The wireless communication system 400 may further include a cloud service 402 that provides custom voice models for various users. The cloud service 402 may be provided by an wireless service operator or a service/hardware vendor.

The UE 410 may include a component 412 that filters or suppresses noise and performs beam forming on the speech signal picked up by one or more microphones of the UE 410. The speech signal may be associated with User 1 who uses the UE 410 to participate in the voice call session. The UE 410 may include standard voice codecs 414 that encodes the speech signal after the speech signal is processed by the noise filter/suppression, beam-forming component 412 for transmission to the UE 420. Because of the environmental noise surrounding the UE 410, as well as the processing by the noise filter/suppression, beam forming component 412 and standard voice codecs 414, the quality of the speech signal transmitted by the UE 410 may be poor. The quality of the speech signal may be further decreased during transmission due to interference, packet loss, and/or trans-coding between operators.

The UE 410 may include an optional on-device learning component 416 that learns a user's custom voice model (e.g., a custom deep generative CNN for User 1) that can increase the speech quality of the user. In one configuration, the custom voice model generated by the on-device learning component 416 may be opted-in (at 418) to be included in the cloud service 402.

The UE 420 may be used by User 2 to participate in the voice call session. The UE 420 may include standard voice codecs 422 that decode the received speech signal to obtain a voice stream. The quality of the voice stream may be poor due to the reasons described above. The UE 420 may include a voice reconstruction block 426 that reconstructs the voice stream generated by the standard voice codecs 422 using a neural network to increase the quality of the speech. As a result, the user of the UE 420 may be able to hear clean high definition (HD) voice.

In one configuration, the voice reconstruction block 426 may be embedded with the generic voice models 424 in order to increase speech quality. The generic voice models 424 may include learned generic voice models (e.g., deep learning generative CNNs) for various languages, sexes, ages, accents, regional dialects, or prosody. The voice reconstruction block 426 may apply one or more of the generic voice models 424 to the voice stream generated by the standard voice codecs 422 based on an initial analysis of the voice stream. In one configuration, the initial analysis of the voice stream may be performed by a neural network.

In one configuration, the voice reconstruction block 426 may be further embedded with the custom voice model 430 (e.g., of User 1) in order to increase speech quality. In one configuration, the UE 420 may opt-in (at 432) to receive the custom voice model 430 from the cloud service 402.

The UE 420 may include an on-device learning component 428 that learns a user's custom voice model (e.g., a custom deep generative CNN for User 2) that may increase the speech quality of the user. In one configuration, the custom voice model generated by the on-device learning component 428 may be opted-in (at 436) to be included in the cloud service 402.

In one configuration, the UE 410 may further include an ASR engine (not shown) that generates a text stream based on the speech signal, e.g., after the speech signal is processed by the component 412. The UE 410 may transmit the text stream to the UE 420 via an out of band communication channel. The voice reconstruction block 426 may use the received text stream during the reconstruction of the voice stream to increase speech quality.

In one configuration, due to voice reconstruction using neural networks, operators of the wireless communication system 400 may achieve wireline quality with half-rate voice within the wireless communication system 400. In one configuration, callers' voices may be reconstructed to HD quality via neural networks without changing to new voice codecs. In one configuration, the custom voice model 430 may be transmitted via a sideband channel (e.g., cloud infrastructure, peer-to-peer communications, or text message/MMS channels) at each call setup, or may be stored within the wireless communication system 400. In one configuration, for increased received & transmitted voice quality, users may share users' custom voice models with friends on the wireless communication system 400. Sharing of custom voice models may be done via an opt-in feature.

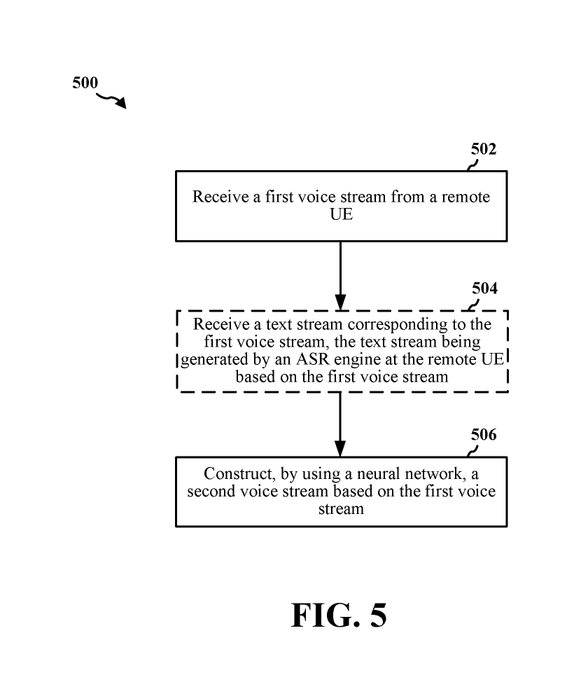

FIG. 5 is a flowchart 500 of a method of wireless communication. The method may be performed by a UE (e.g., the UE 320, 420, or the apparatus 1102/1102′). At 502, the UE may receive a first voice stream from a remote UE (e.g., the UE 310 or 410). In some cases, as in a speakerphone, the recognition of a voice (e.g., the first voice stream) and the translation to a synthesized voice may happen on the same device since the SNR of the voice may need to be improved or a particular speaker may need to be isolated. In other cases, the first voice stream may be received wirelessly from a remote UE.

At 504, the UE may optionally receive a text stream corresponding to the speech in the first voice stream. The text stream may be generated by an ASR engine at the remote UE based on the first voice stream. In one configuration, instead of or in conjunction with the text stream, lower level voice features including phonements may be received to aid speech reconstruction.

At 506, the UE may construct, by using a neural network, a second voice stream based on the first voice stream. In one configuration, operations performed at 506 may include the operations performed by the voice reconstruction block 326 or 426 described above with reference to FIG. 3 or 4, respectively. In one configuration, the neural network may provide one or more voice models for the constructing of the second voice stream. In one configuration, the one or more voice models may include a set of generic voice models (e.g., the generic voice models 324 or 424) for one or more of various languages, sexes, ages, accents, regional dialects, or prosody. In one configuration, the one or more voice models may include a custom voice model (e.g., the custom voice model 430) associated with a user at the remote UE. The custom voice model may be generated by training a specific neural network based on the voice of the user. Data may be sent to the cloud so that voice models may be learned on device or in the cloud. In one configuration, the custom voice model may be received out-of-band from the first voice stream. In one configuration, the second voice stream may be further constructed based on the text stream.

In one configuration, the UE may identify (e.g., through classification) in real time the voice of the user speaking in the first voice stream. That way the method may pull up appropriate user models based on who is speaking. The classification technique may be based on a neural network that detects the particular voice features. For example, a first person is talking on the phone, the first person may put a second person on the phone, and the voice model switches to the second person's voice.

In one configuration, transfer learning or other neural network based learning may be used to increase the rate of learning to customize a voice model to a specific user. It may take too long to learn a person's voice model from scratch. Instead, pre-trained “generic” models with a rich feature set may be presented to a second neural networks, auto-encoder, etc. Fine-tuning may also be used as a form of transfer learning.

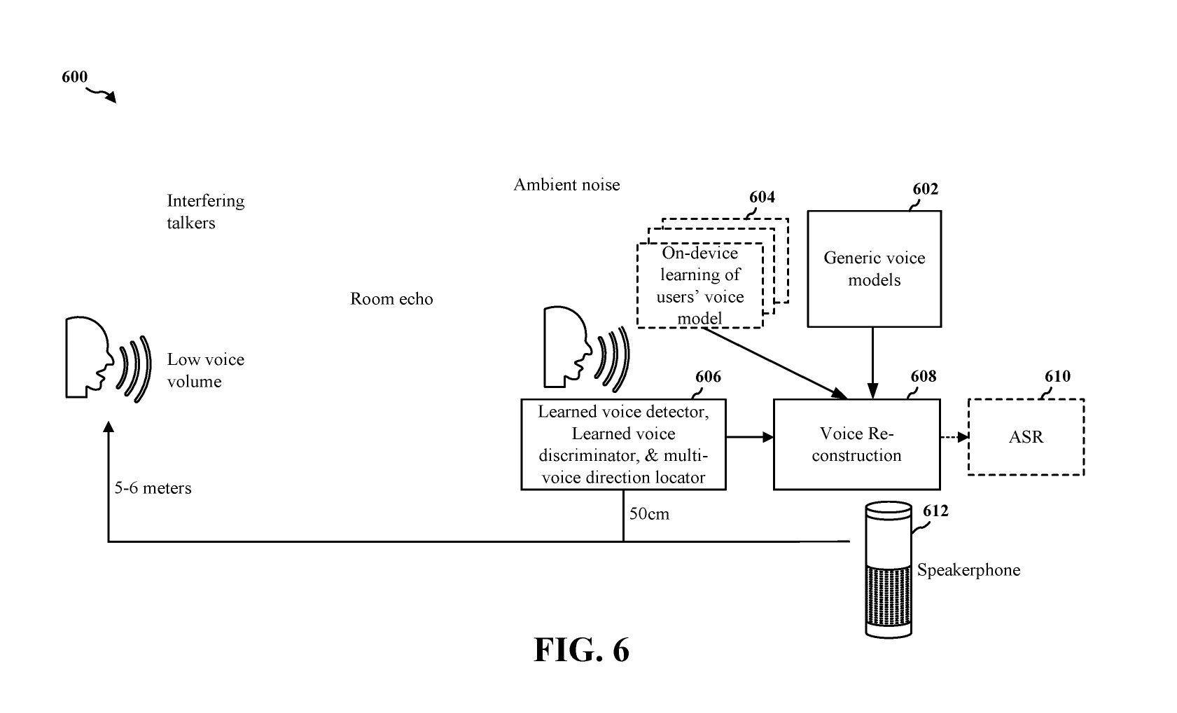

FIG. 6 is a diagram 600 illustrating an example of applying voice reconstruction using a neural network to increase speakerphone voice quality. In the example, a speakerphone 612 may have one or more microphones to pick up the speech signal of a particular talker. In one configuration, the speakerphone 612 may be part of an Internet of things (IoT) smart speaker.

In one configuration, the particular talker may have variable voice characteristics. For example, the voice from the particular talker may be far away (e.g., 5-6 meters) from the speakerphone, 612 and/or have a low voice volume, or the voice from the particular talker may be close to the speakerphone 612 (e.g., 50 cm away). There may be interfering talkers, room echoes, and/or ambient noise. Therefore, the speech signal of the particular talker picked up by the speakerphone 612 may be of reduced quality.

In one configuration, the speakerphone 612 may include a voice reconstruction block 608 that reconstructs the speech signal using a neural network to increase the quality of the speech. In one configuration, the voice reconstruction block 608 may be embedded with the generic voice models 602 in order to increase speech quality. The generic voice models 602 may include learned generic voice models (e.g., deep learning generative CNNs) for various languages, sexes, ages, accents, regional dialects, or prosody. The voice reconstruction block 608 may apply one or more of the generic voice models 602 to the speech signal based on an initial analysis of the speech signal. In one configuration, the initial analysis of the voice stream may be performed by a neural network, e.g., using a generative model for speech which may be conditioned on different speaker identities. Generative models can be constructed that produce audio wave forms directly to facilitate voice reconstruction by use of special convolutional neural networks. Additionally, voice can be reconstructed in a more computationally tractable way by concatenation of speech samples, but at a potential cost of lower quality speech.

In one configuration, the speakerphone 612 may include an on-device learning component 604 that learns custom voice models (e.g., custom deep generative CNNs) for multiple talkers. In one configuration, the custom voice models generated by the on-device learning component 604 may be used in the voice reconstruction block 608 to increase speakerphone voice quality. In one configuration, the voice reconstruction block 608 may further use a component 606 to increase speakerphone voice quality. The component 606 may include one or more of a learned voice detector, a learned voice discriminator, or a multi-voice direction locator. In one configuration, the output of the voice reconstruction block 608 may be provided to an ASR engine 610 to increase speech ASR accuracy.

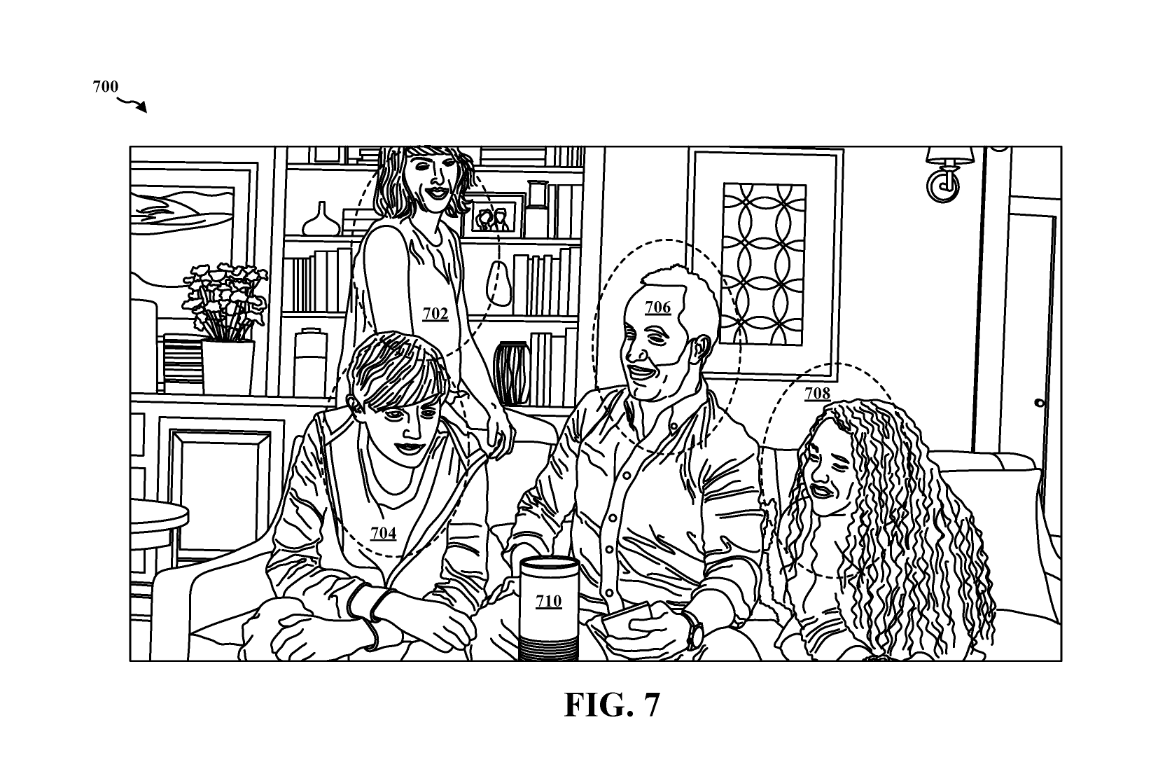

FIG. 7 is a diagram 700 illustrating an example of using neural networks to increase speakerphone voice quality. In the example, speakerphone 710 may receive voice signals from four users 702, 704, 706, and 708 speaking at the same time. In one configuration, the speakerphone 710 may utilize various mechanisms enabled through deep learning to increase speakerphone voice quality.

For example, individual users may be identified through “voice print” (may be referred to as voice biometrics) features learned per each unique voice. Because of the voice biometrics, understanding each person even though multiple persons may be speaking at the same time may be possible. In one configuration, the voice biometrics of a user may be the custom voice model (e.g., 430) described above. In one configuration, voice biometrics may be used to detect, e.g., by a learned voice detector, a particular user's voice. In one configuration, voice biometrics may be used, e.g., by a learned voice discriminator, to discriminate one person's voice from other persons' voices.

In one configuration, a neural network may be trained to detect the attention focus of a particular user's voice. For example, the neural network may be able to detect that user 702 speaks in a top-down direction. In one configuration, a neural network may be trained to detect the distance of a particular user's voice to the speakerphone 710. For example, a detector may be built to detect near or far signals. High frequencies and low frequencies may propagate with different attenuations and may reflect off of surfaces depending on the frequency and surface materials. Accordingly, signals from distance sources may be distinct from signals from nearer sources and a relative change in distance may results in a shift in an acoustic signature. Based on the learned voice features, the speakerphone 710 may be able to filter out interfering talkers' voices. In one configuration, the features described above with reference to FIG. 7 may be incorporated into the component 606 described above with reference to FIG. 6.

In one configuration, speech output may be reconstructed on the back end (e.g., the receiving end) of the voice communication. In one configuration, an over-sampled generative temporal convolutional auto-encoder network may be used for voice reconstruction. In one configuration, temporal network may be substituted with clockwork network (or recurrent neural network (RNN)) to handle voice aging and temporal effects of different voices. In one configuration, multiple neural networks may be jointly learned from speech data with unsupervised learning. For example, a high fidelity speech model for multiple voices (e.g., voice biometrics) may be learned to increase speech quality, a deep learning based voice discriminator and a voice activity detector may be learned to detect and discriminate a voice signal (e.g., in low signal-to-noise ratio (SNR), a directional beam former function may be learned to localize each voice of a plurality of multiple voices, a neural network may be trained to recover the accurate speech signal output by reducing room echo and channel problems (e.g., transcoding problems).

In one configuration, over-sampling may be applied to increase sound directionality (microphone diversity) and quality during training and utilizing of the neural networks. For example, localization may be performed with 3-4 microphones (e.g., for IoT/smart speaker use case). In one configuration, a talker's voice embeddings (voice model) may be captured, learned, and updated on-device. In one configuration, low-latency challenges for mobile devices may be solved as mobile devices may be able to reconstruct a voice stream with less than 10-20 ms delay, e.g., by utilizing hardware acceleration.

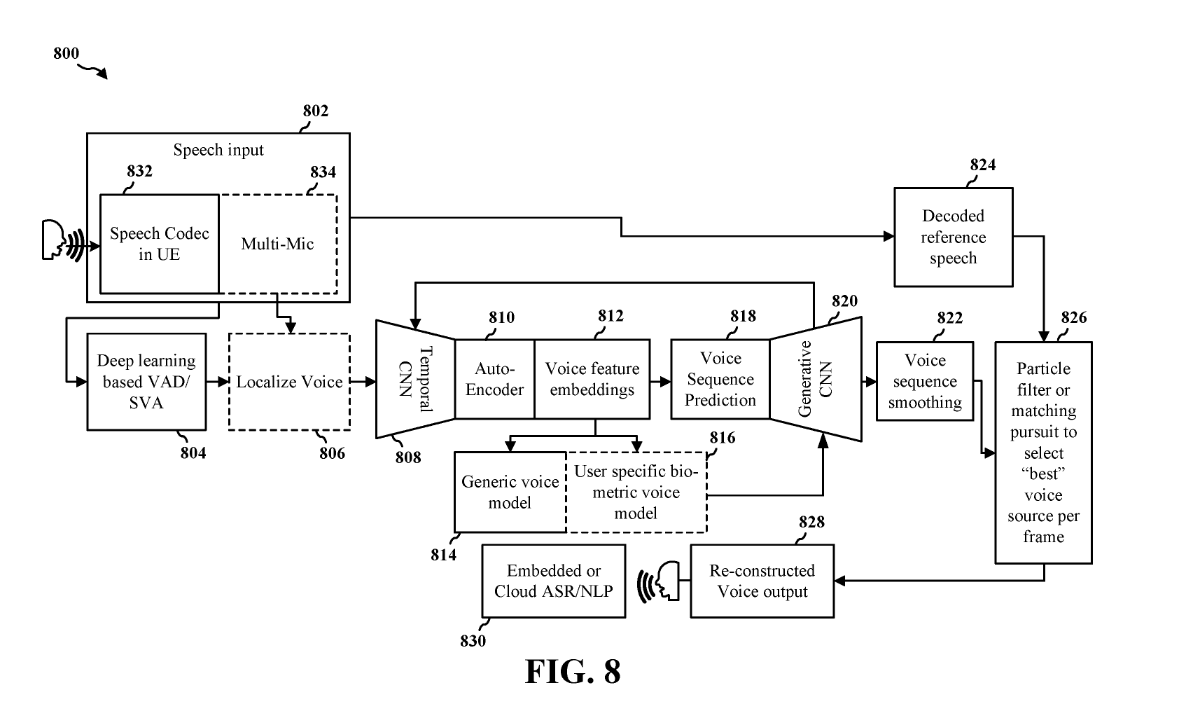

FIG. 8 is a block diagram 800 illustrating an example of voice reconstruction. In one configuration, the voice reconstruction block 326, 426, or 608 described above may perform the operations described below with reference to FIG. 8.

The speech input 802 may be generated by different means depending on different use cases. In one configuration, the speech input 802 may be generated by a speech codec 832 in a UE. In another configuration, the speech input 802 may be generated by multiple microphones 834 of a UE. The speech input 802 may be processed by a deep learning based voice activity detection (VAD) component 804 to detect the presence of different human voices. The speech input 802 generated by the multiple microphones 834 may optionally be processed (at 806) to localize each different human voice.

The speech signal may then be processed by a temporal CNN 808. The output of the temporal CNN 808 may be processed by an auto-encoder 810, followed by further processing by voice feature embeddings 812. The voice feature embeddings 812 may generate a generic voice model 814 based on the speech signal. In one configuration, the voice feature embeddings 812 may optionally generate a user specific biometric voice model 816 based on the speech signal. The output of voice feature embeddings 812 may be provided to a voice sequence prediction block 818, followed by a generative CNN 820. The generative CNN 820 may utilize the generic voice model 814. The generative CNN 820 may further utilize the user specific biometric voice model 816. The output of the generative CNN 820 may be processed by a voice sequence smoothing block 822, followed by a block 826 that uses particle filters or matching pursuit to select the best voice source per frame. The block 826 may take decoded reference speech 824 as input. The output of the block 826 may be a reconstructed voice output 828. In one configuration, the reconstructed voice output 828 may be provided to an embedded or cloud ASR or natural language processing (NLP) block 830 for further processing.

In one configuration, raw speech from the transmit side may be detected and captured, and cleaner high fidelity speech output may be reconstructed (either optimized for human listening fidelity, or optimized for speech recognition fidelity). In one configuration, an over-sampling technique may be used to increase the spatial diversity of multiple microphones. In one configuration, a generative temporal convolutional auto-encoder neural network may be used to learn and then generate high fidelity voice. In one configuration, a temporal network may be substituted with a 3D neural network, clockwork network (or RNN) implementation. In one configuration, a temporal network may be used to handle voice aging and temporal envelope effects of different voices.

In one configuration, multiple neural networks (localization, saliency, voice discriminator/detection, voice modeling, and/or voice generation) may be jointly learned and optimized from speech data with unsupervised learning. In one configuration, a high fidelity speech embeddings model may be learned for multiple voices. A user's voice may have multiple voice patterns/characteristics depending on whether the user is speaking in a noisy environment, in a soft voice, etc. The voice print captures these characteristics to enable identification of the user under various conditions that may be considered as a user's biometric voice print. In one configuration, a deep learning based voice discriminator may be learned. The voice discriminator is a voice activity detector that detects and discriminates voice signal in low SNR, triggers on voice/speech, and rejects detected environmental noise. In one configuration, over-sampled directional beam former function may be used to discriminate and localize in space each voice of multiple voices.

In one configuration, speech quality may be recovered through re-generation of the accurate speech signal output by eliminating room echo, channel problems (e.g., transcoding, dropout), distance effects of voice (e.g., volume and frequency response being different at different distances). In one configuration, over-sampling may be applied to increase sound directionality (e.g., microphone diversity) and quality. In one configuration, scalable multi-channel localization may be performed using 3-4 microphones, up to 8 microphones.

In one configuration, a talker's voice embeddings (or voice model) may be captured, learned, and updated on-device. The system may be robust from noise effects in the local environment. In one configuration, existing mobile phone communications may be improved through side-channel information such as the voice models. In one configuration, the underlying codecs or operator infrastructure or 3GPP/3GPP2 standards may not need to be changed. Instead, cloud infrastructure, peer-to-peer communications, or existing text message/MMS channels may be used to send sideband voice model information to the caller and receiver parties in a phone call. This may maintain codec & standards compliance by creating a new sideband channel mechanism during call setup.

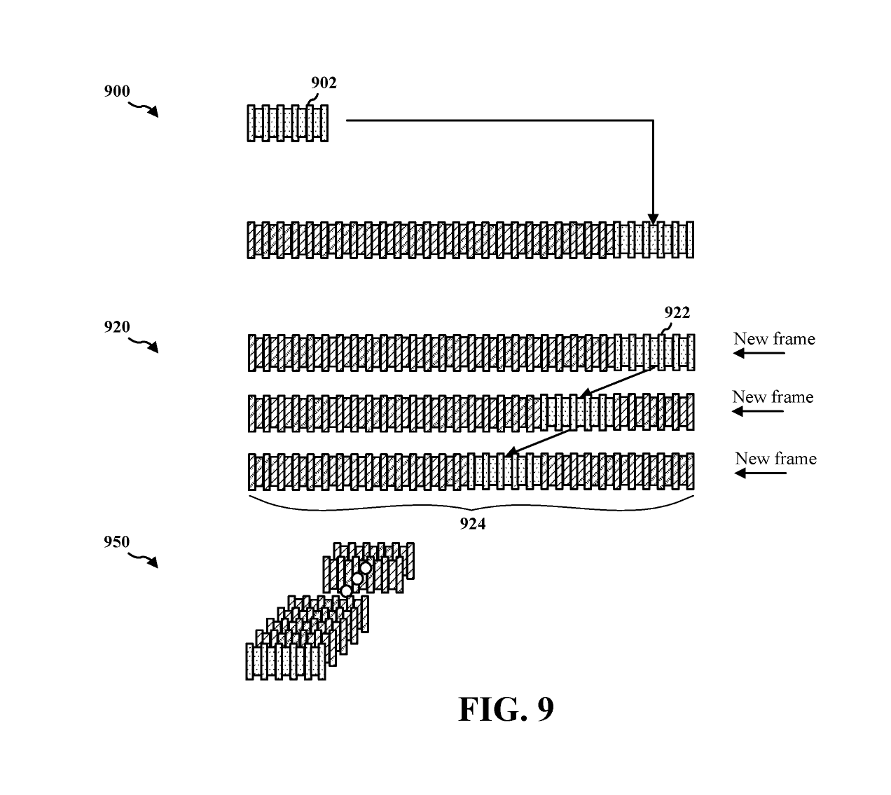

FIG. 9 are diagrams illustrating an example of using CNN with direct convolution of normalized voice samples. In one configuration, the CNN may be the temporal CNN 808 or generative CNN 820 described above in FIG. 8. As shown in diagram 900, the voice samples may be organized in 5 ms frames (e.g., frame 902). Therefore, there may be 80 samples in each frame if the sampling rate is 16 kHz, and 160 samples in each frame if the sampling rate is 32 kHz. Unlike speech recognition which may use 20 ms or 25 ms frames, a higher frame rate may be used to reduce latency and increase generative quality. In one configuration, each new frame may be convolved with n−1 previous frames in the speech sequence. For example, for 1 second of speech, n may be 200, thus 200 frames may be convolved together.

As shown in diagram 920, a sliding window 924 may be created with n frames. With each new frame (e.g., 922), the sliding window 924 may be incremented by a frame time (e.g., 5 ms, or possibly 2.5 ms for higher accuracy). The sliding window 924 may be convolved within the latency of a frame time.

In one configuration, by convolved together the frames, e.g. 200 frames, the sliding window frames 950 may be similar to a 3 dimensional (3D) convolution. Temporal CNN may include space and time features by convolving previous temporal frames together. Thus, long-term temporal variations in a voice may be learned. The CNN may learn the temporal features (time-based features) distributed spatially in the CNN. In one configuration, instead of the temporal CNN, an RNN or clockwork CNN may be used to reconstruct the voice.

In one configuration, the voice sample may not be represented using mel-frequency cepstrum (MFC), etc. In one configuration, CNN convolution may be related to a fast Fourier transform (FFT). With enough convolutions and network depth, enough classification features or embeddings may be obtained without the overhead of MFC conversion.

In one configuration, for reduced voice delay, latency (e.g., CNN and Generative CNN latency) may be 10 ms, which may allow two voice prediction samples per frame.

Frequency response or equalization problems may distort a voice signal picked up by beams. Beams may also pick up more noise in-line with the beam, and opposite the beam. In one configuration, beam-forming accuracy may be increased with a data-driven approach using deep learning, resulting in the use of fewer microphones, and reduced cost. In one configuration, an over-sampling technique may be used to increase beam-forming accuracy.

In one configuration, oversampling may increase microphone spatial diversity. At 16 kHz sampling rate, there may be a 1 to 3 time sample difference between waveforms at mic1, mic2, and mic3 on a small device. Thus, computing temporal disparity needed to find sound direction may be difficult. At a 192 kHz over-sampling rate, there may be a 35-40 sample difference between the waveforms at the microphones. Therefore, 192 kHz sample rates may be used in one configuration. In one configuration, the large temporal difference due to over-sampling may be used to learn sound source spatial direction.

In one configuration, a CNN may be jointly trained on multi-channel microphone data to learn sound sources from different directions. The CNN may be trained to pick up voice instead of other interfering sounds.

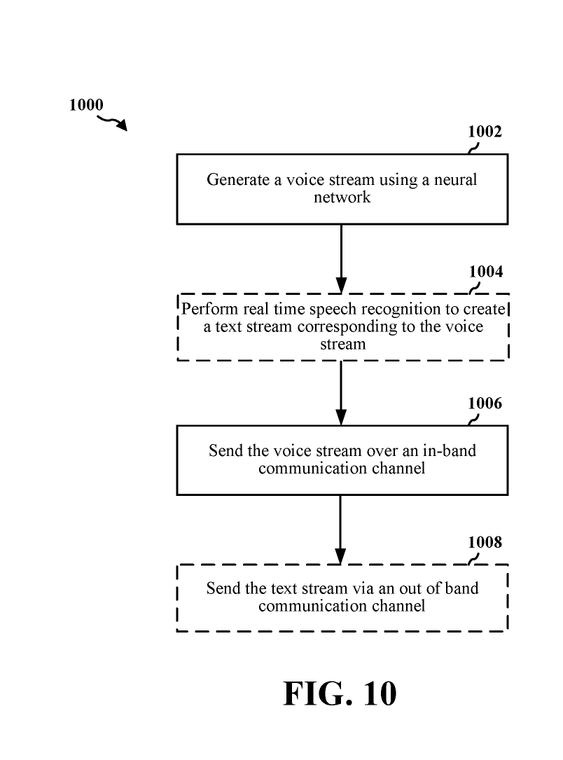

FIG. 10 is a flowchart 1000 of a method of wireless communication. The method may be performed by a UE (e.g., the UE 310, 410, the speakerphone 612, 710, or the apparatus 1102/1102′). At 1002, the UE may generate a voice stream using a neural network. In one configuration, operations performed at 1002 may include the operations performed by the voice reconstruction block 608 described above with reference to FIG. 6.

In one configuration, the neural network may provide a set of voice models. The set of voice models may include generic voice models. In one configuration, the neural network may provide a custom voice model associated with a talker at the UE. In one configuration, the voice stream may be generated further based on one or more of a learned voice detector, a learned voice discriminator, or a multi-voice direction locator. In one configuration, over-sampling may be applied by a neural network, the learned voice detector, the learned voice discriminator, and/or the multi-voice direction locator. In one configuration, the over-sampling rate may be 192,000 samples per second.

At 1004, the UE may optionally perform real time speech recognition to create a text stream corresponding to the voice stream. At 1006, the UE may send the voice stream over an in-band communication channel. At 1008, the UE may optionally send the text stream via an out of band communication channel.

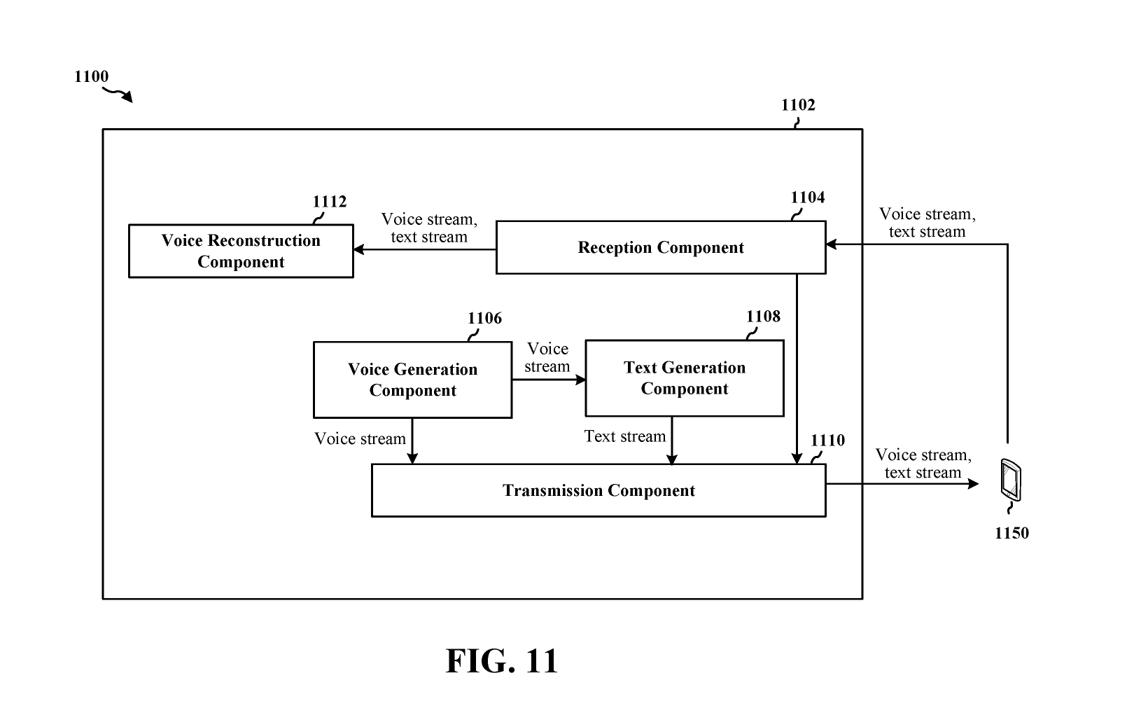

FIG. 11 is a conceptual data flow diagram 1100 illustrating the data flow between different means/components in an exemplary apparatus 1102. The apparatus 1102 may be a UE. The apparatus 1102 may include a reception component 1104 that receives voice stream and/or text stream from a UE 1150. In one configuration, the reception component 1104 may perform operations described above with reference to 502 or 504 in FIG. 5.

In an aspect, the apparatus 1102 may include a transmission component 1110 that transmits voice stream and/or text stream to the UE 1150. The reception component 1104 and the transmission component 1110 may work together to conduct wireless communications for the apparatus 1102. In one configuration, the transmission component 1110 may perform operations described above with reference to 1006 or 1008 in FIG. 5. (In another aspect, a wired or other connection may be used instead of a wireless communication. For example, a virtual assistant may use a wireless or wired connection incorporating aspects of the systems and methods described herein.)

The apparatus 1102 may include a voice reconstruction component 1112 that reconstruct the voice stream to improve speech quality. In one configuration, the voice reconstruction component 1112 may use the text stream to reconstruct the voice stream. In one configuration, the voice reconstruction component 1112 may perform operations described above with reference to 506 in FIG. 5.

The apparatus 1102 may include a voice generation component 1106 that generates a voice stream using a neural network. In one configuration, the voice generation component 1106 may perform operations described above with reference to 1002 in FIG. 10.

The apparatus 1102 may include a text generation component 1108 that generates a text stream based on the voice stream. In one configuration, the text generation component 1108 may perform operations described above with reference to 1004 in FIG. 10.

The apparatus may include additional components that perform each of the blocks of the algorithm in the aforementioned flowcharts of FIGS. 5 and 10. As such, each block in the aforementioned flowcharts of FIGS. 5 and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

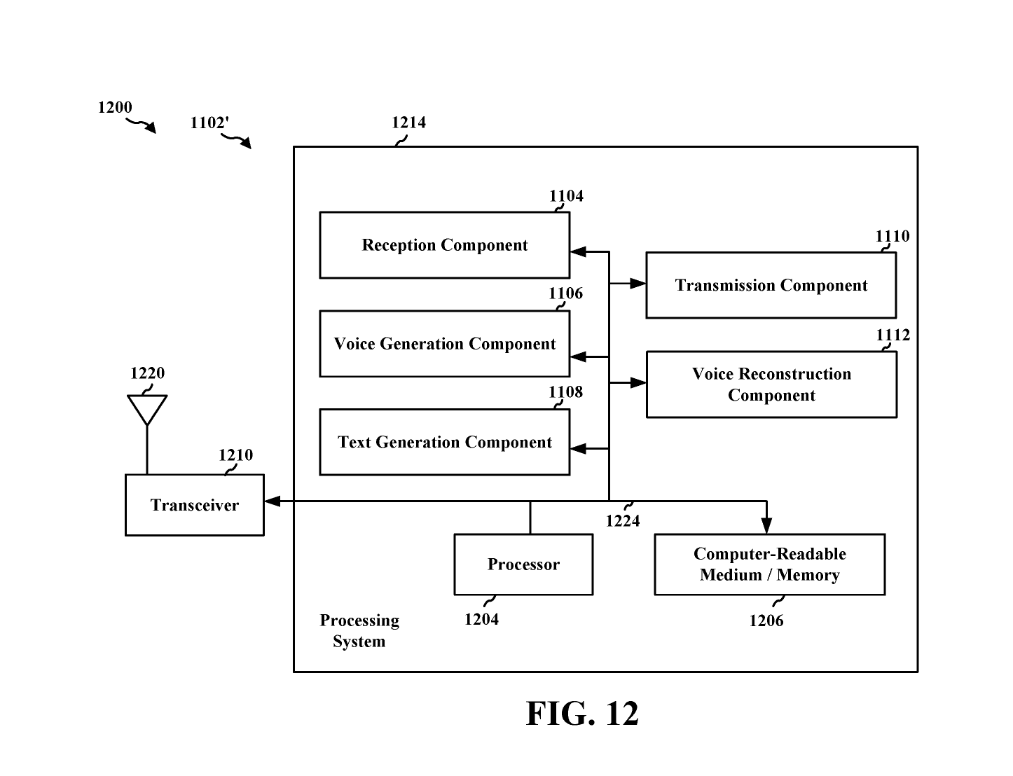

FIG. 12 is a diagram 1200 illustrating an example of a hardware implementation for an apparatus 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware components, represented by the processor 1204, the components 1104, 1106, 1108, 1110, 1112, and the computer-readable medium/memory 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The transceiver 1210 receives a signal from the one or more antennas 1220, extracts information from the received signal, and provides the extracted information to the processing system 1214, specifically the reception component 1104. In addition, the transceiver 1210 receives information from the processing system 1214, specifically the transmission component 1110, and based on the received information, generates a signal to be applied to the one or more antennas 1220. The processing system 1214 includes a processor 1204 coupled to a computer-readable medium/memory 1206. The processor 1204 is responsible for general processing, including the execution of software stored on the computer-readable medium/memory 1206. The software, when executed by the processor 1204, causes the processing system 1214 to perform the various functions described supra for any particular apparatus. The computer-readable medium/memory 1206 may also be used for storing data that is manipulated by the processor 1204 when executing software. The processing system 1214 further includes at least one of the components 1104, 1106, 1108, 1110, 1112. The components may be software components running in the processor 1204, resident/stored in the computer readable medium/memory 1206, one or more hardware components coupled to the processor 1204, or some combination thereof.

In one configuration, the apparatus 1102/1102′ for wireless communication may include means for receiving a first voice stream from a remote UE. (In other examples, the apparatus 1102/1102′ may use wired or communication type.) In one configuration, the means for receiving a first voice stream may perform operations described above with reference to 502 in FIG. 5. In one configuration, the means for receiving a first voice stream may include the transceiver 1210, the one or more antennas 1220, the reception component 1104, and/or the processor 1204.

In one configuration, the apparatus 1102/1102′ may include means for constructing a second voice stream based on the first voice stream. In one configuration, the means for constructing a second voice stream based on the first voice stream may perform operations described above with reference to 506 in FIG. 5. In one configuration, the means for constructing a second voice stream based on the first voice stream may include the voice reconstruction component 1112 and/or the processor 1204.

In one configuration, the apparatus 1102/1102′ may include means for receiving a text stream corresponding to the first voice stream. In one configuration, the means for receiving a text stream corresponding to the first voice stream may perform operations described above with reference to 504 in FIG. 5. In one configuration, the means for receiving a text stream corresponding to the first voice stream may include the transceiver 1210, the one or more antennas 1220, the reception component 1104, and/or the processor 1204.

In one configuration, the apparatus 1102/1102′ may include means for generating a voice stream using a neural network. In one configuration, the means for generating a voice stream using a neural network may perform operations described above with reference to 1002 in FIG. 10. In one configuration, the means for generating a voice stream using a neural network may include the voice generation component 1106 and/or the processor 1204.

In one configuration, the apparatus 1102/1102′ may include means for sending the voice stream over an in-band communication channel. In one configuration, the means for sending the voice stream over an in-band communication channel may perform operations described above with reference to 1006 in FIG. 10. In one configuration, the means for sending the voice stream over an in-band communication channel may include the transceiver 1210, the one or more antennas 1220, the transmission component 1110, and/or the processor 1204.

In one configuration, the apparatus 1102/1102′ may include means for performing real time speech recognition to create a text stream corresponding to the voice stream. In one configuration, the means for performing real time speech recognition to create a text stream corresponding to the voice stream may perform operations described above with reference to 1004 in FIG. 10. In one configuration, the means for performing real time speech recognition to create a text stream corresponding to the voice stream may include the text generation component 1108 and/or the processor 1204.

In one configuration, the apparatus 1102/1102′ may include means for sending the text stream via an out of band communication channel. In one configuration, the means for sending the text stream via an out of band communication channel may perform operations described above with reference to 1008 in FIG. 10. In one configuration, the means for sending the text stream via an out of band communication channel may include the transceiver 1210, the one or more antennas 1220, the transmission component 1110, and/or the processor 1204.

The aforementioned means may be one or more of the aforementioned components of the apparatus 1102 and/or the processing system 1214 of the apparatus 1102′ configured to perform the functions recited by the aforementioned means.

The specific order or hierarchy of blocks in the processes/flowcharts disclosed is an illustration of exemplary approaches. Based upon design preferences, the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication, comprising:
receiving a first voice stream from a remote user equipment (UE); and
constructing, by using a neural network, a second voice stream based on the first voice stream.

2. The method of claim 1, wherein the neural network provides one or more voice models for the constructing the second voice stream, wherein the method further comprises:
identifying in real time a voice of a user in the first voice stream; and
selecting the one or more voice models based on the identified voice.

3. The method of claim 2, wherein the one or more voice models comprise a set of generic voice models for one or more of various languages, sexes, ages, accents, regional dialects, or prosody.

4. The method of claim 2, wherein the one or more voice models comprise a custom voice model associated with a user at the remote UE.

5. The method of claim 4, wherein the custom voice model is generated by training a specific neural network based on voice of the user.

6. The method of claim 4, wherein the custom voice model is received out-of-band from the first voice stream.

7. The method of claim 1, further comprising:
receiving a text stream corresponding to the first voice stream, wherein the text stream is generated by an automatic speech recognition engine at the remote UE based on the first voice stream, wherein the second voice stream is constructed further based on the text stream.

8. An apparatus for wireless communication, comprising:
means for receiving a first voice stream from a remote user equipment (UE); and
means for constructing, by using a neural network, a second voice stream based on the first voice stream.

9. The apparatus of claim 8, wherein the neural network provides one or more voice models for the constructing the second voice stream, wherein the apparatus further comprises:
means for identifying in real time a voice of a user in the first voice stream; and
means for selecting the one or more voice models based on the identified voice.

10. The apparatus of claim 9, wherein the one or more voice models comprise a set of generic voice models for one or more of various languages, sexes, ages, accents, regional dialects, or prosody.

11. The apparatus of claim 9, wherein the one or more voice models comprise a custom voice model associated with a user at the remote UE.

12. The apparatus of claim 11, wherein the custom voice model is generated by training a specific neural network based on voice of the user.

13. The apparatus of claim 8, further comprising:
means for receiving a text stream corresponding to the first voice stream, wherein the text stream is generated by an automatic speech recognition engine at the remote UE based on the first voice stream, wherein the second voice stream is constructed further based on the text stream.

14. An apparatus for wireless communication, comprising:
a memory; and
at least one processor coupled to the memory and configured to:
receive a first voice stream from a remote user equipment (UE); and
construct, by using a neural network, a second voice stream based on the first voice stream.

15. The apparatus of claim 14, wherein the neural network provides one or more voice models for the constructing the second voice stream, wherein the at least one processor is further configured to:
identify in real time a voice of a user in the first voice stream; and
select the one or more voice models based on the identified voice.

16. The apparatus of claim 15, wherein the one or more voice models comprise a set of generic voice models for one or more of various languages, sexes, ages, accents, regional dialects, or prosody.

17. The apparatus of claim 15, wherein the one or more voice models comprise a custom voice model associated with a user at the remote UE.

18. The apparatus of claim 17, wherein the custom voice model is generated by training a specific neural network based on voice of the user.

19. The apparatus of claim 17, wherein the custom voice model is received out-of-band from the first voice stream.

20. The apparatus of claim 14, wherein the at least one processor is further configured to:
receive a text stream corresponding to the first voice stream, wherein the text stream is generated by an automatic speech recognition engine at the remote UE based on the first voice stream, wherein the second voice stream is constructed further based on the text stream.
